(19) United States
(12) Patent Application Publication
(10) Pub. No.: US 2026/0321476 A1
(43) Pub. Date: Oct. 15, 2026

(54) CONTROL CIRCUIT FOR SOLENOID VALVE

(71) Applicant: SMC CORPORATION, Tokyo (JP)

(72) Inventor: Koichi KATSUMATA, Tsukubamirai-shI (JP)

(73) Assignee: SMC CORPORATION, Tokyo (JP)

(21) Appl. No.: 19/481,948

(22) PCT Filed: May 11, 2023
(86) PCT No.: PCT/JP2023/017763

§ 371 Date: Nov. 6, 2025

(51) Int. Cl. H01F 7/06; F16K 31/06; H01F 7/08

(52) U.S. Cl. CPC H01F 7/064; F16K 31/0658; F16K 31/0675; H01F 7/081

(57) ABSTRACT

A control circuit for a solenoid valve having a solenoid coil is provided with: a current feedback bias circuit that has a transistor in which a base electrode is connected to a pull-up resistor and a pull-down resistor, an emitter electrode is connected to an emitter resistor connected to the ground, and a collector electrode is connected to a load resistor, and that amplifies an AC component of a first voltage corresponding to a current flowing through the solenoid coil; and a voltage output circuit that outputs a second voltage, which changes in accordance with the amplified AC component, to a determination device.

### TECHNICAL FIELD

The present invention relates to a control circuit for a solenoid valve.

### BACKGROUND ART

JP H09-097116 A discloses a coil driving/iron core movement detecting circuit for a solenoid valve. The coil driving/iron core movement detecting circuit supplies an excitation current to the electromagnetic coil of the solenoid valve and detects a change in the excitation current. Consequently, the movement of the movable iron core is detected, and the opening of the valve element of the solenoid valve is detected.

### SUMMARY OF THE INVENTION

The coil driving/iron core movement detecting circuit for the solenoid valve disclosed in JP H09-097116 A is large in scale. Therefore, a large mounting space is required.

The present invention has the object of solving the aforementioned problem.

An aspect of the present invention is characterized by a control circuit for a solenoid valve including a solenoid coil, the control circuit comprising: a current feedback bias circuit that includes a transistor including a base, an emitter, and a collector, the base being connected to a pull-up resistor and a pull-down resistor that are configured to divide a supply voltage supplied from a power source, the emitter being connected to an emitter resistor connected to a ground, the collector being connected to a load resistor connected to the power source, the current feedback bias circuit being configured to amplify an alternating current component of a first voltage that corresponds to a current flowing through the solenoid coil, the alternating current component being applied to the base; and a voltage output circuit configured to output, to a determination device, a second voltage that changes according to the alternating current component that has been amplified by the current feedback bias circuit, the determination device being configured to determine communication between an input port and an output port of the solenoid valve based on the second voltage.

According to the present invention, the scale of the control circuit for the solenoid valve can be suppressed.

### BRIEF DESCRIPTION OF DRAWINGS

FIG. 1 is a diagram showing an application example of a control circuit for a solenoid valve;

FIG. 2 is a diagram illustrating a change in current flowing through a solenoid coil;

FIG. 3 is a diagram for explaining a configuration example of the control circuit;

FIG. 4 is a diagram illustrating a change in voltage; and

FIG. 5A and FIG. 5B are diagrams illustrating changes in voltage with temperature.

### DETAILED DESCRIPTION OF THE INVENTION

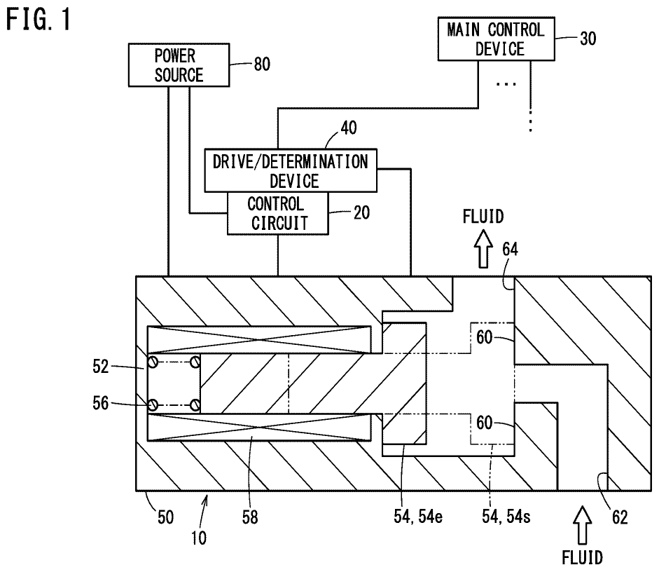

FIG. 1 is a diagram showing an application example of a control circuit 20 for a solenoid valve 10. A main control device 30 controls the solenoid valve 10 via a drive/determination device 40 and the control circuit 20 based on an operation by an operator. The main control device 30 is, for example, a PC (Personal Computer) or a PLC (Programmable Logic Controller). The main control device 30 can control a plurality of the solenoid valves 10.

In the present embodiment, the drive/determination device 40 and the control circuit 20 are provided for each solenoid valve 10. The drive/determination device 40 and the control circuit 20 may be provided for the plurality of solenoid valves 10. The drive/determination device 40 and the control circuit 20 may be provided in the main control device 30.

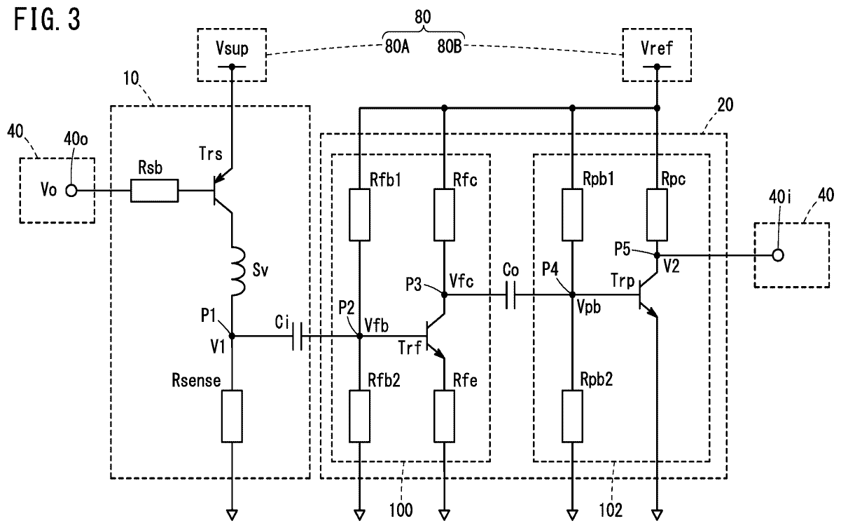

The drive/determination device 40 includes a processor such as a CPU (Central Processing Unit) or a GPU (Graphics Processing Unit). The drive/determination device 40 outputs a drive control signal for driving the solenoid valve 10. Further, the drive/determination device 40 determines communication between an input port 62 and an output port 64 of the solenoid valve 10 based on the voltage obtained from the control circuit 20. The configuration of the control circuit 20 will be described later with reference to FIG. 3. Low-voltage electric power is supplied from a power source 80 to the control circuit 20.

FIG. 1 schematically shows the configuration of the solenoid valve 10. The solenoid valve 10 includes a fixed iron core 52, a movable iron core 54, a spring 56, and a solenoid coil 58 in a case 50. The movable iron core 54 can be brought into contact with a valve seat 60 formed in the case 50 of the solenoid valve 10 by an elastic force (repulsive force) of the spring 56. The movable iron core 54 that is in contact with the valve seat 60 is shown by a two-dot chain line as a movable iron core 54s in FIG. 1.

The state in which the movable iron core 54 is in contact with the valve seat 60 is a valve-closed state of the solenoid valve 10. In the valve-closed state, communication between the input port 62 and the output port 64 for a fluid formed in the case 50 of the solenoid valve 10 is blocked.

In the case where the drive/determination device 40 outputs a drive control signal to the solenoid valve 10, electric power is supplied from the power source 80 to the solenoid coil 58. That is, a current flows through the solenoid coil 58. In this case, a magnetic force is generated. The magnetic force causes the movable iron core 54 to move toward the fixed iron core 52 against the elastic force of the spring 56. The movable iron core 54 is separated from the valve seat 60. The state in which the movable iron core 54 is separated from the valve seat 60 is a valve-open state of the solenoid valve 10.

When the solenoid valve 10 is brought into the valve-open state, the input port 62 and the output port 64 start to communicate with each other. The fluid flows into the input port 62, flows from the input port 62 to the output port 64, and flows out of the output port 64. The movable iron core 54, which has thereafter further moved and reached a terminal end of a movable section, is indicated by a solid line as a movable iron core 54e in FIG. 1. In the case where the movable iron core 54 has reached the terminal end of the movable section, the solenoid valve 10 is in a fully open state.

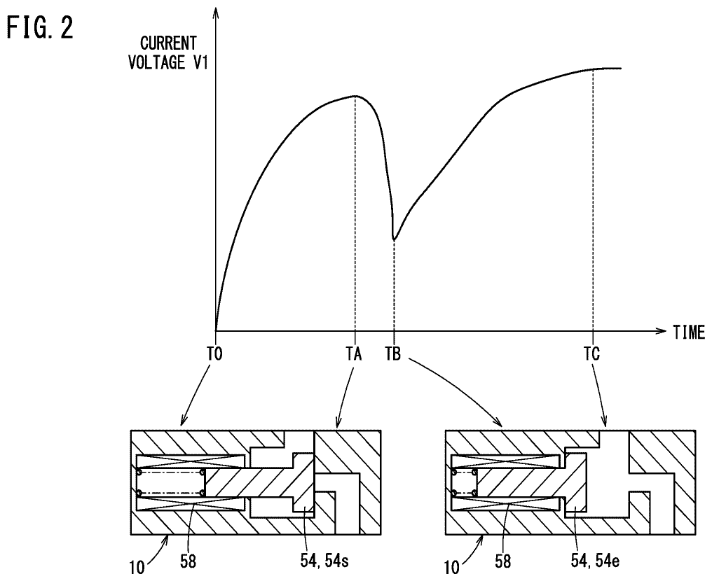

FIG. 2 is a diagram illustrating a change in the current flowing through the solenoid coil 58. At time T0, the current starts to flow through the solenoid coil 58 of the solenoid valve 10 that is in the valve-closed state. In this case, a force that moves the movable iron core 54 (54s), which has brought the solenoid valve 10 into the valve-closed state, toward the fixed iron core 52 starts to be generated. However, the movable iron core 54 does not move until the force becomes larger than the elastic force of the spring 56. During this time, the current flowing through the solenoid coil 58 increases.

At time TA, the force that moves the movable iron core 54 of the solenoid valve 10 that is in the valve-closed state balances with the elastic force of the spring 56. After the time TA, the force becomes larger than the elastic force of the spring 56. Therefore, the movable iron core 54 is separated from the valve seat 60 and starts to move in the solenoid coil 58. The solenoid valve 10 is brought into the valve-open state. As the movable iron core 54 moves in the solenoid coil 58, the inductance of the solenoid coil 58 increases. Therefore, the current flowing through the solenoid coil 58 decreases.

At time TB, the movable iron core 54 (54e) that has reached the terminal end of the movable section stops moving. When the movable iron core 54 stops moving, the inductance of the solenoid coil 58 stops changing. Therefore, after the time TB, the current flowing through the solenoid coil 58 increases. Thereafter, at time TC, the increase in the current flowing through the solenoid coil 58 stops. The movable iron core 54 remains stopped at the terminal end of the movable section. After the time TC, the current flowing through the solenoid coil 58 is maintained at a constant value in a state where the movable iron core 54 is stopped.

A first voltage V1, which is obtained by subtracting the voltage drop caused by the solenoid coil 58 from the voltage (for example, 24 [V]) supplied from the power source 80 to the solenoid valve 10, changes in the same manner as the current flowing through the solenoid coil 58. That is, the first voltage V1 changes with time as shown in FIG. 2 in accordance with the current flowing through the solenoid coil 58.

At the time TB, the solenoid valve 10 is brought into the fully open state. In this case, the input port 62 and the output port 64 completely communicate with each other. There are cases where the main control device 30 should detect an inter-port communication state in which the input port 62 and the output port 64 completely communicate with each other. The main control device 30 can detect the inter-port communication state based on the first voltage V1. In order to detect the inter-port communication state, the control circuit 20 according to the present embodiment is used.

FIG. 3 is a diagram for explaining a configuration example of the control circuit 20. The control circuit 20 outputs, to the drive/determination device 40, a second voltage V2 obtained based on the above-described first voltage V1 corresponding to the current flowing through the solenoid coil 58. The second voltage V2 will be described in detail later. The power source 80 includes a drive power source 80A for the solenoid valve 10, and a low-voltage power source 80B for the control circuit 20. A supply voltage Vref (for example, 3.3 [V]), which is lower than the voltage of the drive power source 80A for the solenoid valve 10, is supplied to the control circuit 20 from the low-voltage power source 80B.

In FIG. 3, the processor of the drive/determination device 40 outputs, as the drive control signal, a voltage Vo to the solenoid valve 10 from an output terminal 40o of the processor. The solenoid valve 10 includes a transistor Trs, a solenoid coil Sv, a current sensing resistor Rsense, a current limiting resistor Rsb, and a coupling capacitor Ci.

The base of the transistor Trs is connected to the output terminal 40o of the processor of the drive/determination device 40 via the current limiting resistor Rsb. The current limiting resistor Rsb limits the current flowing through the base of the transistor Trs. The emitter of the transistor Trs is connected to the drive power source 80A that outputs a supply voltage Vsup. As described above, the supply voltage Vsup is, for example, 24 [V]. The collector of the transistor Trs is connected to the solenoid coil Sv.

The current sensing resistor Rsense is connected to a point P1 corresponding to the other end of the solenoid coil Sv among both ends of the solenoid coil Sv, which is on the opposite side to one end thereof connected to the collector of the transistor Trs. The current sensing resistor Rsense is connected to the ground.

The transistor Trs is turned on by the voltage Vo being output from the output terminal 40o. In this case, the current from the drive power source 80A flows through the solenoid coil Sv. By providing the current sensing resistor Rsense connected to the point P1 and the ground, the first voltage V1 at the point P1 is obtained.

The coupling capacitor Ci is disposed between the point P1 and the control circuit 20. The control circuit 20, which is supplied with the low supply voltage Vref from the low-voltage power source 80B, is isolated by the coupling capacitor Ci from the solenoid valve 10, which is supplied with the supply voltage Vsup from the drive power source 80A. Circuit constants such as a resistance value and a capacitor capacitance used for the control circuit 20 can be determined independently of the solenoid valve 10. The coupling capacitor Ci removes the DC component from the first voltage V1 and extracts the AC component of the first voltage V1.

The control circuit 20 includes a current feedback bias circuit 100, a voltage output circuit 102, and a coupling capacitor Co. The coupling capacitor Co of the control circuit 20 is disposed between the current feedback bias circuit 100 and the voltage output circuit 102. The current feedback bias circuit 100 includes only one transistor Trf provided with a base, an emitter, and a collector. The base of the transistor Trf is connected to a pull-up resistor Rfb1 and a pull-down resistor Rfb2. The pull-up resistor Rfb1 is connected to the low-voltage power source 80B. The pull-down resistor Rfb2 is connected to the ground.

That is, one end of the pull-up resistor Rfb1 is connected to the low-voltage power source 80B, and the other end of the pull-up resistor Rfb1 is connected to the pull-down resistor Rfb2. One end of the pull-down resistor Rfb2 is connected to the pull-up resistor Rfb1, and the other end of the pull-down resistor Rfb2 is connected to the ground. It should be noted that, in the present embodiment, the pull-up resistor Rfb1 and the pull-down resistor Rfb2 are included in the current feedback bias circuit 100.

The base of the transistor Trf is connected to a point P2 located between the pull-up resistor Rfb1 and the pull-down resistor Rfb2. The coupling capacitor Ci of the solenoid valve 10 is also connected to the point P2. That is, both electrodes of the coupling capacitor Ci are respectively connected to the point P1 of the solenoid valve 10 and the point P2 of the current feedback bias circuit 100.

The emitter of the transistor Trf is connected to an emitter resistor Rfe. The emitter resistor Rfe is connected to the ground. That is, one end of the emitter resistor Rfe is connected to the emitter of the transistor Trf, and the other end of the emitter resistor Rfe is connected to the ground. It should be noted that, in the present embodiment, the emitter resistor Rfe is included in the current feedback bias circuit 100.

The collector of the transistor Trf is connected to a load resistor Rfc. The load resistor Rfc is connected to the low-voltage power source 80B. That is, one end of the load resistor Rfc is connected to the low-voltage power source 80B, and the other end of the load resistor Rfc is connected to the collector of the transistor Trf. It should be noted that, in the present embodiment, the load resistor Rfc is included in the current feedback bias circuit 100.

The coupling capacitor Co of the control circuit 20 is connected to a point P3 located between the load resistor Rfc and the collector of the transistor Trf. The voltage output circuit 102 is isolated from the current feedback bias circuit 100 by the coupling capacitor Co. Circuit constants such as a resistance value used for the voltage output circuit 102 can be determined independently of the current feedback bias circuit 100.

The voltage output circuit 102 includes only one transistor Trp including a base, an emitter, and a collector. The base of the transistor Trp is connected to a pull-up resistor Rpb1 and a pull-down resistor Rpb2. The pull-up resistor Rpb1 is connected to the low-voltage power source 80B. The pull-down resistor Rpb2 is connected to the ground.

That is, one end of the pull-up resistor Rpb1 is connected to the low-voltage power source 80B, and the other end of the pull-up resistor Rpb1 is connected to the pull-down resistor Rpb2. One end of the pull-down resistor Rpb2 is connected to the pull-up resistor Rpb1, and the other end of the pull-down resistor Rpb2 is connected to the ground. It should be noted that, in the present embodiment, the pull-up resistor Rpb1 and the pull-down resistor Rpb2 are included in the voltage output circuit 102.

The base of the transistor Trp is connected to a point P4 located between the pull-up resistor Rpb1 and the pull-down resistor Rpb2. The coupling capacitor Co of the control circuit 20 is also connected to the point P4. That is, both electrodes of the coupling capacitor Co are respectively connected to the point P3 of the current feedback bias circuit 100 and the point P4 of the voltage output circuit 102. The emitter of the transistor Trp is connected to the ground. The transistor Trp is a transistor enabling open collector output.

The collector of the transistor Trp is connected to a load resistor Rpc. The load resistor Rpc is connected to the low-voltage power source 80B. That is, one end of the load resistor Rpc is connected to the low-voltage power source 80B, and the other end of the load resistor Rpc is connected to the collector of the transistor Trp. It should be noted that, in the present embodiment, the load resistor Rpc is included in the voltage output circuit 102.

An input terminal 40i of the processor of the drive/determination device 40 is connected to a point P5 located between the load resistor Rpc and the collector of the transistor Trp. The voltage output circuit 102 (the collector of the transistor Trp) outputs the second voltage V2 at the point P5 to the processor of the drive/determination device 40. The second voltage V2 output from the voltage output circuit 102 is input to the input terminal 40i.

As described above, the first voltage V1 at the point P1 changes with time as shown in FIG. 2. The second voltage V2 at the point P5 also changes with time in accordance with the change with time in the first voltage V1. This will be described below. First, the current feedback bias circuit 100 that amplifies the AC component of the first voltage V1 extracted by the coupling capacitor Ci will be described.

As described above, the solenoid valve 10 is connected to the drive power source 80A. The control circuit 20 is connected to the low-voltage power source 80B whose supply voltage is lower than that of the drive power source 80A. The control circuit 20 is isolated from the solenoid valve 10 by the coupling capacitor Ci located between the point P1 and the point P2.

Therefore, the voltage level of a voltage Vfb at the point P2 in the current feedback bias circuit 100 is a voltage level shifted from the voltage level of the first voltage V1 at the point P1 in the solenoid valve 10. The operating point of the transistor Trf whose base is connected to the point P2 corresponds to a voltage obtained by dividing, by the pull-up resistor Rfb1 and the pull-down resistor Rfb2 of the current feedback bias circuit 100, the supply voltage Vref supplied from the low-voltage power source 80B.

The voltage Vfb at the point P2 is the AC component of the first voltage V1 extracted by the coupling capacitor Ci. The voltage Vfb at the point P2 is amplified by the transistor Trf of the current feedback bias circuit 100. The gain corresponding to the amplification factor is determined according to the ratio between the resistance value of the load resistor Rfc connected to the collector of the transistor Trf and the resistance value of the emitter resistor Rfe connected to the emitter of the transistor Trf. Therefore, at the point P3 in the current feedback bias circuit 100, a voltage Vfc amplified more than the voltage Vfb at the point P2 is obtained. The voltage Vfc changes according to the voltage Vfb, which is the AC component of the first voltage V1.

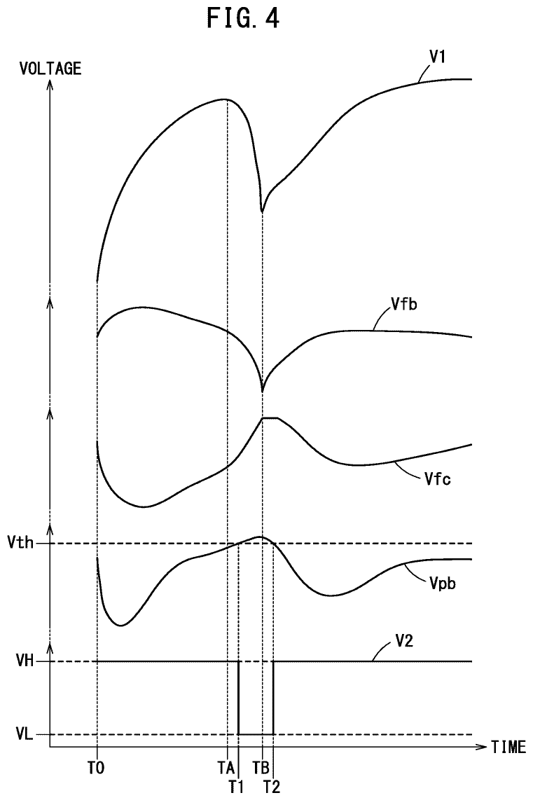

Further, the emitter of the transistor Trf is connected to the ground via the emitter resistor Rfe. Therefore, when the voltage Vfb at the point P2 rises, the voltage Vfc at the point P3 drops, and when the voltage Vfb at the point P2 drops, the voltage Vfc at the point P3 rises. That is, the waveform indicating the change with time in the voltage Vfc at the point P3 is inverted with respect to the waveform indicating the change with time in the voltage Vfb at the point P2. This feature will be described later with reference to FIG. 4.

A DC voltage amplification factor hfe and a base-emitter voltage Vbe of the transistor Trf of the current feedback bias circuit 100 are obtained as characteristics of the transistor Trf. Further, the supply voltage Vref of the low-voltage power source 80B is determined in advance, for example, to be 3.3 [V]. The ratio between the current flowing through the pull-up resistor Rfb1 and the current flowing through the base of the transistor Trf, the resistance value of the emitter resistor Rfe, and the resistance value of the load resistor Rfc, are determined according to the required specifications such as the above-described gain when the current feedback bias circuit 100 is designed. The resistance value of the pull-up resistor Rfb1 and the resistance value of the pull-down resistor Rfb2 can be determined based on the various constants obtained in this manner.

Next, the voltage output circuit 102 will be described. The coupling capacitor Co shifts the voltage level of the voltage Vfc at the point P3 in the current feedback bias circuit 100. A voltage Vpb at the point P4 in the voltage output circuit 102 is obtained according to the voltage Vfc whose voltage level has been shifted. The operating point of the transistor Trp whose base is connected to the point P4 corresponds to a voltage obtained by dividing, by the pull-up resistor Rpb1 and the pull-down resistor Rpb2 of the voltage output circuit 102, the supply voltage Vref supplied from the low-voltage power source 80B.

The voltage Vpb changes according to the voltage Vfc. Therefore, the voltage Vpb changes according to the voltage Vfb, which is the AC component of the first voltage V1. In the case where the voltage Vpb exceeds a voltage corresponding to the operating point of the transistor Trp, the transistor Trp is turned on. That is, the voltage corresponding to the operating point of the transistor Trp functions as a predetermined threshold Vth for the transistor Trp to be turned on. As described below, threshold control for changing the second voltage V2 by using the predetermined threshold Vth can be performed.

In the case where the transistor Trp is turned on, the second voltage V2 at the point P5 in the voltage output circuit 102 becomes a ground potential VL. Therefore, in the case where the voltage Vpb, which changes according to the voltage Vfb that is the AC component of the first voltage V1, exceeds the predetermined threshold Vth, the collector of the transistor Trp outputs the ground potential VL as the second voltage V2.

In the case where the voltage Vpb is less than the predetermined threshold Vth, the transistor Trp is turned off. In the case where the transistor Trp is in the off state, the second voltage V2 at the point P5 in the voltage output circuit 102 becomes a predetermined voltage VH higher than the ground potential VL. The predetermined voltage VH corresponds to the supply voltage Vref of the low-voltage power source 80B. Therefore, in the case where the voltage Vpb is less than the predetermined threshold Vth, the collector of the transistor Trp outputs the predetermined voltage VH as the second voltage V2.

As described above, the predetermined threshold Vth takes a value corresponding to the supply voltage Vref of the low-voltage power source 80B, and the resistance values of the pull-up resistor Rpb1 and the pull-down resistor Rpb2 of the transistor Trp. Therefore, the predetermined threshold Vth may be determined in advance so that the on state and the off state of the transistor Trp are appropriately switched according to the change in the voltage Vpb at the point P4. In this case, the resistance values of the pull-up resistor Rpb1 and the pull-down resistor Rpb2 of the transistor Trp are determined based on the determined predetermined threshold Vth and the supply voltage Vref of the low-voltage power source 80B.

As described above, the second voltage V2 output from the collector of the transistor Trp is input to the input terminal 40i of the processor of the drive/determination device 40. Therefore, the predetermined voltage VH may be determined according to the specification of the processor or the like of the drive/determination device 40. The load resistor Rpc of the voltage output circuit 102 is determined to have a resistance value sufficiently smaller than the input impedance of the input terminal 40i so that the determined predetermined voltage VH is output from the collector of the transistor Trp. However, it is preferable to employ a design that can prevent a large current from flowing through the transistor Trp due to the resistance value of the load resistor Rpc being too small.

The drive/determination device 40 determines the communication between the input port 62 and the output port 64 of the solenoid valve 10 based on the second voltage V2 output from the voltage output circuit 102 and input to the input terminal 40i. In the case where the second voltage V2 input to the input terminal 40i indicates the ground potential VL, it is determined that the movable iron core 54 has just reached the terminal end of the movable section or the movable iron core 54 will soon reach the terminal end of the movable section. In this case, the timing at which the input port 62 and the output port 64 of the solenoid valve 10 completely communicate with each other has come or is coming soon.

In the case where the second voltage V2 input to the input terminal 40i indicates the predetermined voltage VH, it is determined that the movable iron core 54 has not reached the terminal end of the movable section or the movable iron core 54 has reached the terminal end of the movable section and stopped moving. In this case, the input port 62 and the output port 64 of the solenoid valve 10 do not completely communicate with each other, or a certain time has elapsed since they have completely communicated with each other.

As is apparent from FIG. 3, the current feedback bias circuit 100 includes only one transistor. The voltage output circuit 102 includes only one transistor. Therefore, the control circuit 20 includes only two transistors, and the scale of the control circuit 20 can be suppressed. The control circuit 20 has a smaller scale than a circuit including many transistors, such as an operational amplifier or a comparator, and therefore does not require a large mounting space. In addition, since the control circuit 20 includes only two transistors, the second voltage V2 can be output with low latency.

Furthermore, the coupling capacitor Ci isolates the control circuit 20 from the solenoid valve 10. Therefore, the supply voltage Vref supplied from the low-voltage power source 80B to the control circuit 20 can be made lower than the supply voltage Vsup supplied from the drive power source 80A to the solenoid valve 10. Since the control circuit 20 can be constituted by circuit elements driven at a low voltage, the control circuit 20 can be realized at low cost.

FIG. 4 is a diagram illustrating a change in voltage. The change in the first voltage V1 at the point P1 (refer to FIG. 3) shown in FIG. 4 is similar to the change in the first voltage V1 shown in FIG. 2. That is, at the time T0, the current starts to flow through the solenoid coil 58 of the solenoid valve 10 that is in the valve-closed state. At the time TA, the movable iron core 54 starts to move. After the time TA, the movable iron core 54 moves in the solenoid coil 58. At the time TB, the movable iron core 54 that has reached the terminal end of the movable section stops moving. After the time TB, the movable iron core 54 remains stopped at the terminal end of the movable section and does not move.

As described above with reference to FIG. 2, the first voltage V1 in FIG. 4 increases from the time T0 to the time TA. At the time TA, the movable iron core 54 starts to move. The first voltage V1 decreases from the time TA to the time TB as the movable iron core 54 moves in the solenoid coil 58. At the time TB, the movable iron core 54 reaches the terminal end of the movable section and stops. The first voltage V1 increases after the time TB.

As described above, the voltage Vfb at the point P2 (refer to FIG. 3) in the current feedback bias circuit 100 is the AC component of the first voltage V1. As shown in FIG. 4, the voltage Vfb changes from decreasing to increasing at the time TB. As described above, the waveform of the voltage Vfc at the point P3 (refer to FIG. 3) in the current feedback bias circuit 100 is inverted with respect to the waveform of the voltage Vfb at the point P2. Therefore, as shown in FIG. 4, the voltage Vfc changes from increasing to decreasing at the time TB.

As described above, the voltage Vpb at the point P4 (refer to FIG. 3) in the voltage output circuit 102 is obtained according to the value obtained by shifting the voltage level of the voltage Vfc at the point P3. The time when the voltage Vpb exceeds the predetermined threshold Vth is defined as time T1. The time T1 is a time between the time TA and the time TB. As shown in FIG. 4, at the time T1, the transistor Trp changes from the off state to the on state.

Thereafter, the time when the voltage Vpb becomes lower than the predetermined threshold Vth is defined as time T2. The time T2 is a time that is substantially the same as the time TB or slightly after the time TB. As shown in FIG. 4, at the time T2, the transistor Trp changes from the on state to the off state. Therefore, the second voltage V2 output from the voltage output circuit 102 (the second voltage V2 at the point P5 in the voltage output circuit 102, refer to FIG. 3) is a pulsating voltage.

Specifically, as shown in FIG. 4, the second voltage V2 becomes the predetermined voltage VH during a period from the time T0 to the time T1. Only during a period from the time T1 to the time T2, the second voltage V2 becomes the ground potential VL. After the time T2, the second voltage V2 becomes the predetermined voltage VH again. That is, the voltage output circuit 102 is a pulse generating circuit including only one transistor Trp.

The drive/determination device 40 can determine the communication between the input port 62 and the output port 64 of the solenoid valve 10 based on the second voltage V2. The main control device 30 can easily detect the inter-port communication state based on the determination result of the drive/determination device 40. In the case where the second voltage V2 changes from the predetermined voltage VH to the ground potential VL at the time T1, the drive/determination device 40 determines that the input port 62 and the output port 64 have completely communicated with each other.

The drive/determination device 40 may determine that the input port 62 and the output port 64 have completely communicated with each other in the case where the second voltage V2 changes from the ground potential VL to the predetermined voltage VH at the time T2. The drive/determination device 40 may determine that the input port 62 and the output port 64 have completely communicated with each other in the case where the second voltage V2 changes at the time T1 and the time T2 and becomes a pulsating voltage.

The pulse width of the voltage pulse obtained by the change of the second voltage V2 at the time T1 and the time T2 is determined according to the capacitance of the coupling capacitor Ci, the resistance value of the pull-up resistor Rfb1 and the resistance value of the pull-down resistor Rfb2 in the current feedback bias circuit 100, the capacitance of the coupling capacitor Co, and the resistance value of the pull-up resistor Rpb1 and the resistance value of the pull-down resistor Rpb2 in the voltage output circuit 102. Therefore, the capacitance of each coupling capacitor and the resistance value of each resistor are determined according to the required specification of the pulse width.

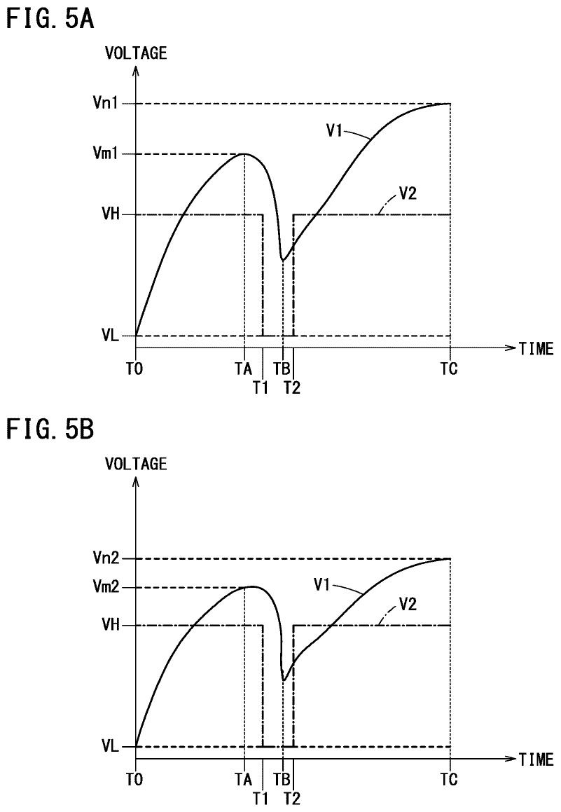

FIG. 5A and FIG. 5B are diagrams illustrating changes in voltage with temperature. FIG. 5A shows the changes with time in the first voltage V1 and the second voltage V2 at a temperature E1. FIG. 5B shows the changes with time in the first voltage V1 and the second voltage V2 at a temperature E2. The temperature E2 is higher than the temperature E1. It should be noted that, although the scale of the vertical axis is different between the first voltage V1 and the second voltage V2, a common vertical axis is used in both FIG. 5A and FIG. 5B for ease of understanding the description.

As shown in FIG. 5A, in the case of the temperature E1, the first voltage V1 is Vm1 at the time TA when the movable iron core 54 starts to move in the solenoid coil 58. After the time TB when the movable iron core 54 reaches the terminal end of the movable section, the first voltage V1 increases again. At the time TC when the increase in the first voltage V1 stops, the first voltage V1 is Vn1. The time T1 when the second voltage V2 changes from the predetermined voltage VH to the ground potential VL is a time between the time TA and the time TB. The time T2 when the second voltage V2 changes from the ground potential VL to the predetermined voltage VH is a time that is substantially the same as the time TB or slightly after the time TB.

When the temperature rises, the resistance of the solenoid coil 58 increases, and therefore the current flowing through the solenoid coil 58 decreases. Accordingly, the first voltage V1 decreases as the temperature increases. As shown in FIG. 5B, in the case of the temperature E2 higher than the temperature E1, the first voltage V1 is Vm2 at the time TA. The value Vm2 of the first voltage V1 at the time TA in the case of the temperature E2 is lower than the value Vm1 of the first voltage V1 at the time TA in the case of the temperature E1.

As shown FIG. 5B, in the case of the temperature E2, the first voltage V1 is Vn2 at the time TC. The value Vn2 of the first voltage V1 at the time TC in the case of the temperature E2 is lower than the value Vn1 of the first voltage V1 at the time TC in the case of the temperature E1. However, the control circuit 20 outputs the second voltage V2 by using, instead of the first voltage V1 itself, the voltage Vfc obtained by amplifying the voltage Vfb, which is the AC component of the first voltage V1.

The current feedback bias circuit 100 that amplifies the voltage Vfb to the voltage Vfc is less likely to be affected by a temperature change. Therefore, as shown in FIG. 5B, in the case of the temperature E2 as well, the time T1 is a time between the time TA and the time TB, and the time T2 is a time substantially the same as the time TB or slightly after the time TB, as in the case of the temperature E1. That is, the control circuit 20 stably outputs the pulsating second voltage V2 even when a temperature change occurs. Therefore, the drive/determination device 40 can stably determine the communication between the input port 62 and the output port 64 of the solenoid valve 10.

The following supplementary notes are further disclosed in relation to the above disclosure.

### Supplementary Note 1

The control circuit (20) for the solenoid valve (10) including the solenoid coil (58) includes: the current feedback bias circuit (100) that includes the transistor (Trf) including the base, the emitter, and the collector, the base being connected to the pull-up resistor (Rfb1) and the pull-down resistor (Rfb2) that are configured to divide the supply voltage (Vref) supplied from the power source (80), the emitter being connected to the emitter resistor (Rfe) connected to the ground, the collector being connected to the load resistor (Rfc) connected to the power source, the current feedback bias circuit being configured to amplify the AC component of the first voltage (V1) that corresponds to the current flowing through the solenoid coil, the AC component being applied to the base; and the voltage output circuit (102) configured to output, to the determination device (40), the second voltage (V2) that changes according to the AC component that has been amplified by the current feedback bias circuit, the determination device being configured to determine communication between the input port (62) and the output port (64) of the solenoid valve based on the second voltage. According to such a configuration, the scale of the control circuit for the solenoid valve can be suppressed.

### Supplementary Note 2

The control circuit for the solenoid valve according to Supplementary Note 1 may further include the coupling capacitor (Co) configured to shift the voltage level of the AC component that has been amplified by the current feedback bias circuit, wherein the voltage output circuit may output the second voltage that changes according to the AC component whose voltage level has been shifted by the coupling capacitor. According to such a configuration, the circuit constants for the voltage output circuit can be determined independently of the current feedback bias circuit.

### Supplementary Note 3

In the control circuit for the solenoid valve according to Supplementary Note 1 or 2, the voltage output circuit may include the transistor (Trp) configured to enable open collector output, and the second voltage may decrease in the case where the AC component exceeds the predetermined threshold (Vth). According to such a configuration, threshold control for changing the second voltage by using the predetermined threshold can be realized.

### Supplementary Note 4

In the control circuit for the solenoid valve according to Supplementary Note 3, the base of the transistor included in the voltage output circuit may be connected to the pull-up resistor (Rpb1) and the pull-down resistor (Rpb2) that are configured to divide the supply voltage supplied from the power source, and the predetermined threshold may be determined according to the resistance values of the pull-up resistor and the pull-down resistor to which the base of the transistor included in the voltage output circuit is connected, and the supply voltage supplied from the power source. According to such a configuration, the voltage corresponding to the operating point of the transistor included in the voltage output circuit can be made to function as the predetermined threshold.

### Supplementary Note 5

In the control circuit for the solenoid valve according to Supplementary Note 3 or 4, the emitter of the transistor included in the voltage output circuit may be connected to the ground, the collector of the transistor included in the voltage output circuit may be connected to the load resistor (Rpc) connected to the power source, and in the case where the AC component exceeds the predetermined threshold, the collector of the transistor included in the voltage output circuit may output the ground potential (VL) of the ground as the second voltage. According to such a configuration, the inter-port communication state of the solenoid valve can be easily detected.

### Supplementary Note 6

In the control circuit for the solenoid valve according to any one of Supplementary Notes 1 to 5, the base of the transistor included in the current feedback bias circuit may be connected to the coupling capacitor (Ci) configured to remove the DC component of the first voltage. According to such a configuration, the control circuit can be realized at low cost.

The present invention is not limited to the above disclosure, and various modifications are possible without departing from the essence and gist of the present invention.

### REFERENCE SIGNS LIST

10: solenoid valve
20: control circuit
30: main control device
40: drive/determination device (determination device)
50: case
52: fixed iron core
54: movable iron core
56: spring
58: solenoid coil
60: valve seat
62: input port
64: output port
80: power source
100: current feedback bias circuit
102: voltage output circuit

1. A control circuit for a solenoid valve including a solenoid coil, the control circuit comprising:
a current feedback bias circuit that includes a transistor including a base, an emitter, and a collector, the base being connected to a pull-up resistor and a pull-down resistor that are configured to divide a supply voltage supplied from a power source, the emitter being connected to an emitter resistor connected to a ground, the collector being connected to a load resistor connected to the power source, the current feedback bias circuit being configured to amplify an alternating current component of a first voltage that corresponds to a current flowing through the solenoid coil, the alternating current component being applied to the base; and
a voltage output circuit configured to output, to a determination device, a second voltage that changes according to the alternating current component that has been amplified by the current feedback bias circuit, the determination device being configured to determine communication between an input port and an output port of the solenoid valve based on the second voltage.

2. The control circuit for the solenoid valve according to claim 1, further comprising a coupling capacitor configured to shift a voltage level of the alternating current component that has been amplified by the current feedback bias circuit, wherein
the voltage output circuit outputs the second voltage that changes according to the alternating current component whose voltage level has been shifted by the coupling capacitor.

3. The control circuit for the solenoid valve according to claim 1, wherein
the voltage output circuit includes a transistor configured to enable open collector output, and the second voltage decreases in a case where the alternating current component exceeds a predetermined threshold.

4. The control circuit for the solenoid valve according to claim 3, wherein
a base of the transistor included in the voltage output circuit is connected to a pull-up resistor and a pull-down resistor that are configured to divide the supply voltage supplied from the power source, and
the predetermined threshold is determined according to resistance values of the pull-up resistor and the pull-down resistor to which the base of the transistor included in the voltage output circuit is connected, and the supply voltage supplied from the power source.

5. The control circuit for the solenoid valve according to claim 3, wherein
an emitter of the transistor included in the voltage output circuit is connected to the ground,
a collector of the transistor included in the voltage output circuit is connected to a load resistor connected to the power source, and
in the case where the alternating current component exceeds the predetermined threshold, the collector of the transistor included in the voltage output circuit outputs a ground potential of the ground as the second voltage.

6. The control circuit for the solenoid valve according to claim 1, wherein
the base of the transistor included in the current feedback bias circuit is connected to a coupling capacitor configured to remove a direct current component of the first voltage.

7. The control circuit for the solenoid valve according to claim 2, wherein
the base of the transistor included in the current feedback bias circuit is connected to a coupling capacitor configured to remove a direct current component of the first voltage.

8. The control circuit for the solenoid valve according to claim 3, wherein
the base of the transistor included in the current feedback bias circuit is connected to a coupling capacitor configured to remove a direct current component of the first voltage.

9. The control circuit for the solenoid valve according to claim 4, wherein
the base of the transistor included in the current feedback bias circuit is connected to a coupling capacitor configured to remove a direct current component of the first voltage.

10. The control circuit for the solenoid valve according to claim 5, wherein
the base of the transistor included in the current feedback bias circuit is connected to a coupling capacitor configured to remove a direct current component of the first voltage.
